(19) United States
(12) Patent Application Publication
(10) Pub. No.: US 2007/0218288 A1
(43) Pub. Date: Sep. 20, 2007

(54) Adapter plate for supporting a vacuum suction device

(76) Inventor: Harald Richter, Engelbrand (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/475,397

(22) Filed: Jun. 27, 2006

(30) Foreign Application Priority Data
Mar. 14, 2006 (DE) 20 2006 004 193.1

(51) Int. Cl. B32B 9/04

(52) U.S. Cl. 428/411.1

(57) ABSTRACT

In an adapter plate for supporting a vacuum suction device, a bottom layer is provided onto which a top layer is applied in liquid form and then cured so as to form a support structure with a top of relatively soft material having a smooth surface and a rounded circumferential edge.

### BACKGROUND OF THE INVENTION

The invention resides in an adapter plate for a vacuum suction device, that is an adapter plate to be mounted on rough or profiled surfaces for supporting vacuum suction devices on such rough and profiled surfaces via the adapter plate, which can be cemented or screwed to a rough or profiled surface, but itself is provided with a smooth surface suitable for retaining a vacuum suction device.

EP 0 844 406, for example, discloses such an adapter plate which is provided at its backside with an adhesive surface and, at its front, has a smooth surface area which is surrounded by an upstanding rim with a diameter slightly exceeding that of the suction foot or the suction membrane of a vacuum suction device to be supported thereon.

It is the object of the present invention to provide an improved adapter plate which can be used more widely, which holds a vacuum suction device more reliably and which is attractive in its appearance when not in use for supporting a vacuum suction device.

### SUMMARY OF THE INVENTION

In an adapter plate for supporting a vacuum suction device, a bottom layer is provided onto which a top layer is applied in liquid form and then cured so as to form a support structure of relatively soft material with a smooth surface and a rounded circumferential edge.

The adapter plate according to the invention does not only not have an upstanding rim, but—in contrast—is even spherically cured along its circumferential edge and can be mounted also on surfaces which are slightly curved and on which conventional adapter plates could not be directly mounted. The cast surface layer of the adapter plate according to the invention provides for a firm connection of a suction device and permits a selection of a multitude of optical appearances.

An exemplary embodiment of the invention will be described below on the basis of the schematic drawings enclosed herewith.

### BRIEF DESCRIPTION OF THE DRAWINGS

FIG. 1 is a top view of an adapter plate according to the invention,

FIG. 2 is a side view of the adapter plate of FIG. 1, and

FIG. 3 shows, enlarged, a section of the edge area of the adapter plate.

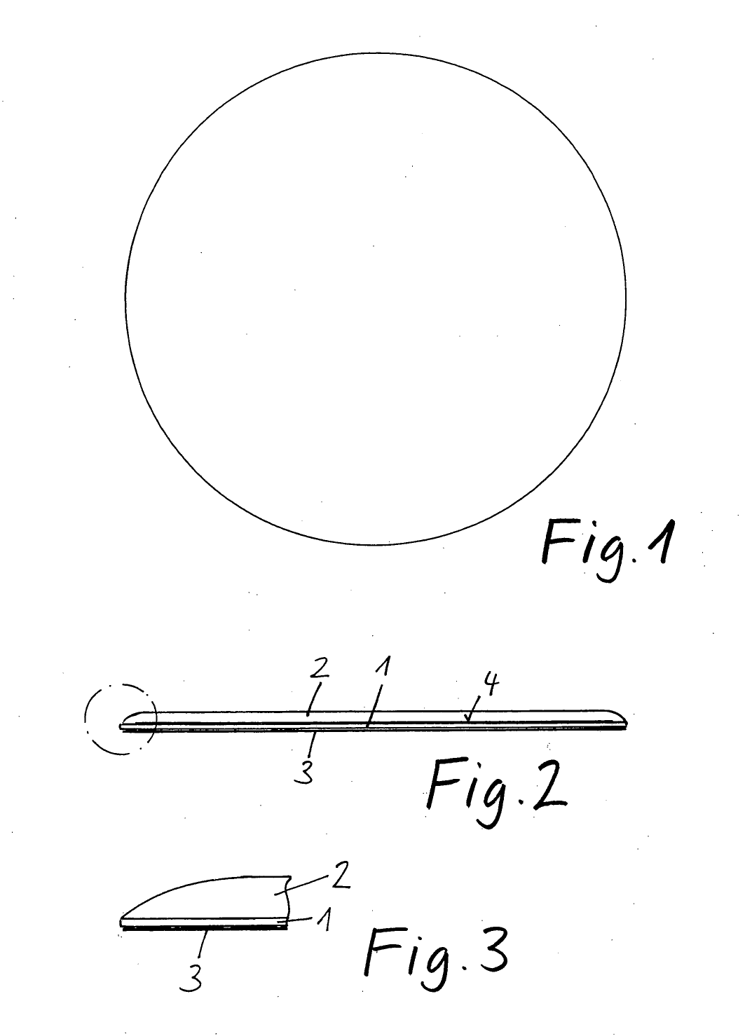

### DESCRIPTION OF A PREFERRED EMBODIMENT

The adapter plate as shown in the figures is circular and, as shown in FIG. 2, comprises two layers. There is a relatively thin bottom layer 1 which consists of PVC and is manufactured from a PVC foil. Further, the adapter plate comprises a relatively thick molded top layer 2 of polyurethane which has been deposited onto the PVC foil forming the bottom layer 1.

A method of manufacturing the adapter plate comprises first punching or, respectively, cutting the PVC foil for providing the bottom layer 1 and then depositing liquid polyurethane on the bottom layer 1. The amount of liquid polyurethane deposited on the bottom layer is so controlled, that the liquid does not run over the edge of bottom layer 1, but, because of the surface tension, remains on the bottom layer 1 as a large, flat drop. In this way, softly rounded edge portions are formed by the polyurethane layer 1 after the curing of the polyurethane. The rounded edge is optically as well as technically very advantageous and is shown enlarged in FIG. 3 covering the circled area of FIG. 2. To the bottom side of the bottom layer 1, a cement layer 3 is then applied which consists of a suitably special cement which renders the adapter plate self adhesive. The cement layer is then covered by a peel-off foil for example.

The top surface of the PVC foil may be provided with a decorative imprint 4 before the top layer 2 is applied so that the decorative imprint is visible through the clear, transparent top layer. The decorative imprint may be any decorative pattern or for example a wood imitation.

The top layer 2 of polyurethane is solid after curing but is still relatively soft in comparison with, for example, hard plastic material. This has not only the advantage that the adapter plate can be curved for adaptation to curvatures of the mounting surface, but the attachment force of a suction foot disposed thereon is also substantially increased in comparison with conventional adapter plates which consist of hard plastic material since the relatively soft surface layer 2 cooperates with a membrane which is also relatively soft. With this cooperation of a relatively soft suction membrane and the relatively soft surface layer 2 of the adapter plate, an extremely good suction connection is obtained.

The known adapter plate is provided with an upstanding rim which serves as a positioning aid for guiding the suction foot upon placement and which is intended to prevent the suction foot from sliding off the adapter plate. In the adapter plate according to the present invention, the cured top layer which has been cast onto the bottom layer forms a smooth curvature along the edge of the adapter plate with the result that a suction foot disposed thereon remains firmly attached even if it is disposed close to the edge area, as the suction membrane and the relatively soft surface layer adapt to one another.

As materials for the embodiment described, PVC foils were used for the bottom layer 1 and polyurethane was used for the top layer 2 which was cast onto the bottom layer 1 and then cured. Of course, other plastic materials may be used which has the same or similar properties and which can be used in the same way.

Instead of the decorative imprints, company names or trademarks may be imprinted on the top side of the bottom layer 1 or they may simply be attached in the form of a label which then after the casting of the top layer and its curing is enclosed and sealed thereby.

The embodiment described herein represents a flexible adapter plate. Basically, however, a more rigid and thicker material may be used such as wood, a metal sheet or a rigid plastic material on which then the top layer is cast. Such an arrangement has the advantage of providing for a better attachment of a suction foot on the adapter plate but, like conventional adapter plates, it must be mounted on flat surfaces.

What is claimed is:

1. An adapter plate for supporting a vacuum suction device, comprising a bottom layer (1) and a top layer (2) cast onto the bottom layer (1) and cured so as to form a supporting top layer of relatively soft material with a smooth surface and a rounded circumferential edge.

2. An adapter plate according to claim 1, wherein the bottom layer (1) consists of a thin plastic foil.

3. An adapter plate according to claim 1, wherein the top layer (2) consists of urethane.

4. An adapter plate according to claim 1, wherein the rounded circumferential edges is formed by depositing a predetermined amount of the top layer material in liquid form on the bottom layer such that it is retained on the bottom layer by the surface tension of the liquid top layer material which is subsequently cured.

5. An adapter plate according to claim 1, wherein the underside of the bottom plate (1) is provided with a self-adhesive cement layer.

6. An adapter plate according to claim 1, wherein one of a decorative imprint and a label is applied to the top side of the bottom layer and encapsulated by the top layer (2) applied to the bottom layer 1.

7. An adapter plate according to claim 6, wherein the top layer is glass-clear transparent.
